(19) United States
(12) Patent Application Publication
(10) Pub. No.: US 2016/0320897 A1
(43) Pub. Date: Nov. 3, 2016

(54) INTERACTIVE DISPLAY SYSTEM, IMAGE CAPTURING APPARATUS, INTERACTIVE DISPLAY METHOD, AND IMAGE CAPTURING METHOD

(71) Applicant: Coretronic Corporation, Hsin-Chu (TW)

(72) Inventor: Kun-You Wu, Hsin-Chu (TW)

(21) Appl. No.: 15/016,266

(22) Filed: Feb. 5, 2016

(30) Foreign Application Priority Data
Apr. 30, 2015 (TW) 104113931

(51) Int. Cl. G06F 3/041; G06F 3/042

(52) U.S. Cl. CPC G06F 3/0416; G06F 3/0421; G06F 3/0425

(57) ABSTRACT

An interactive display system, an image capturing apparatus, an interactive display method, and an image capturing method are provided. An indicating unit of the image capturing apparatus emits an indicating light beam to form an indicating pattern on an image provided by a display unit, and the indicating pattern is configured to assist at least one of a user and a processing unit in determining an operating range.

### CROSS-REFERENCE TO RELATED APPLICATION

This application claims the priority benefit of Taiwan application serial no. 104113931, filed on Apr. 30, 2015. The entirety of the above-mentioned patent application is hereby incorporated by reference herein and made a part of this specification.

### BACKGROUND OF THE INVENTION

1. Field of the Invention

The invention relates to an electronic apparatus, and particularly relates to an interactive display system, an image capturing apparatus, an interactive display method and an image capturing method.

2. Description of Related Art

As electronic apparatuses are developed toward a trend of multifunction, a conventional button-type operation interface has been gradually unable to meet the needs of users. In this case, an interactive touch technique is quickly developed. Compared with the conventional button-type operation interface, an input method of an interactive touch operation interface is more convenient and intuitive, and a user directly performs a touch input on a display surface of the electronic apparatus by using a finger or a stylus. Besides that the interactive touch technique is applied to the display surface of the electronic apparatus, it is also applied to a projection screen on which images are projected by a projection apparatus, such that the user performs the touch input on the projection screen.

In an interactive display system of optical projection, the user directly performs operations on the projection screen through projection of a laser light. However, regarding the current interactive display system, when a distance between the projection apparatus and the projection screen or between an image capturing apparatus and the projection screen is changed, a sensing range of the interactive touch is accordingly changed. However, the user is required to re-measure or adjust a relative position of the devices in the interactive display system when the distance between the projection apparatus and the projection screen or the distance between the image capturing apparatus and the projection screen is changed, so as to get a correct sensing range. Since an adjusting process is very complicated, the user may feel inconvenient in usage.

The information disclosed in this “BACKGROUND” section is only for enhancement of understanding of the background of the described technology and therefore it may contain information that does not form the prior art that is already known to a person of ordinary skill in the art. Further, the information disclosed in this “BACKGROUND” section does not mean that one or more problems to be resolved by one or more embodiments of the invention was acknowledged by a person of ordinary skill in the art.

### SUMMARY OF THE INVENTION

The invention is directed to an interactive display system, an image capturing apparatus, an interactive display method, and an image capturing method, which may assist a user to quickly determine an image capturing position of the image capturing apparatus, such that a displayed image or a sensing range of an interactive operation may be easily adjusted to a required position, so as to greatly improve usage convenience.

Other objects and advantages of the invention can be further illustrated by the technical features broadly embodied and described as follows.

In order to achieve one or a portion of or all of the objects or other objects, an embodiment of the invention provides an interactive display system including a display unit and an image capturing apparatus. The display unit is configured to display an image, and the image capturing apparatus is configured to capture at least a part of the image. The image capturing apparatus includes an image capturing unit, an indicating unit, and a processing unit. The image capturing unit is configured to generate a capturing image. The indicating unit is configured to emit an indicating light beam to form an indicating pattern on the image. The processing unit is coupled to the image capturing unit, and is configured to control the image capturing unit to capture at least a part of the image to generate the capturing image. The indicating pattern is configured to assist at least one of a user and the processing unit in determining an operating range.

In an embodiment of the invention, the display unit is a projector, and the projector is configured to project the image.

In an embodiment of the invention, at least one of the user and the processing unit determines the operating range by aligning the indicating pattern with at least a part of the image.

An embodiment of the invention provides an image capturing apparatus including an indicating unit, an image capturing unit, and a processing unit. The indicating unit is configured to emit an indicating light beam to form an indicating pattern on an image capturing target. The image capturing unit is configured to generate a capturing image. The processing unit is coupled to the image capturing unit, and is configured to control the image capturing unit to capture the image capturing target to generate the capturing image. The indicating pattern is configured to assist at least one of a user and the processing unit in determining an operating range.

In an embodiment of the invention, at least one of the user and the processing unit determines the operating range by aligning the indicating pattern with the image capturing target.

An embodiment of the invention provides an interactive display method. The interactive display method is adapted to an interactive display system, and includes following steps. A display unit of the interactive display system is used to display an image. An indicating unit of the interactive display system is used to emit an indicating light beam, so as to form an indicating pattern on at least a part of the image. An image capturing apparatus of the interactive display system is used to capture at least a part of the image to generate a capturing image. The indicating pattern is configured to assist at least one of a user and the image capturing apparatus in determining an operating range.

In an embodiment of the invention, the step of using the display unit of the interactive display system to display the image includes using the display unit to project an image light beam to a projection surface, so as to display the image on the projection surface.

In an embodiment of the invention, the step that the indicating pattern assists at least one of the user and the image capturing apparatus in determining the operating range includes at least one of the user and the image capturing apparatus determining the operating range by aligning the indicating pattern with at least a part of the image.

In an embodiment of the invention, the operating range is an interactive display range of the interactive display system.

An embodiment of the invention provides an image capturing method. The image capturing method is adapted to an image capturing apparatus. The image capturing method includes following steps. An indicating unit of the image capturing apparatus is used to emit an indicating light beam, so as to form an indicating pattern on an image capturing target. An image capturing unit of the image capturing apparatus is used to capture the image capturing target to generate a capturing image. The indicating pattern is configured to assist at least one of a user and the image capturing apparatus in determining an operating range.

In an embodiment of the invention, the step that the indicating pattern assists at least one of the user and the image capturing apparatus in determining the operating range includes at least one of the user and the image capturing apparatus determining the operating range by aligning the indicating pattern with the image capturing target.

In an embodiment of the interactive display system, the image capturing apparatus, the interactive display method, and the image capturing method of the invention, the indicating light beam is a visible light beam.

In an embodiment of the interactive display system, the image capturing apparatus, the interactive display method, and the image capturing method of the invention, the indicating pattern has a plurality of indicating spots.

In an embodiment of the interactive display system, the image capturing apparatus, the interactive display method, and the image capturing method of the invention, the operating range is an image capturing range of the image capturing apparatus (image capturing unit).

According to the above descriptions, the embodiment of the invention forms the indicating pattern on the image to assist at least one of the user and the processing unit in determining the operating range through the indicating light beam emitted by the indicating unit, the user is assisted to quickly determine an image capturing position, such that the sensing range of the interactive touch may be adjusted to the required position, therefore usage convenience is greatly improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of an image capturing apparatus according to an embodiment of the invention.

FIG. 1B and FIG. 1C are block diagrams of the image capturing apparatus according to two embodiments of the invention.

FIG. 2 is a schematic diagram of an interactive display system according to an embodiment of the invention.

FIG. 3 is a schematic diagram of an interactive display system according to another embodiment of the invention.

FIG. 4 is a schematic diagram of an interactive display system according to another embodiment of the invention.

FIG. 5 is a flowchart illustrating an image capturing method according to an embodiment of the invention.

FIG. 6 is a flowchart illustrating an interactive display method according to another embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

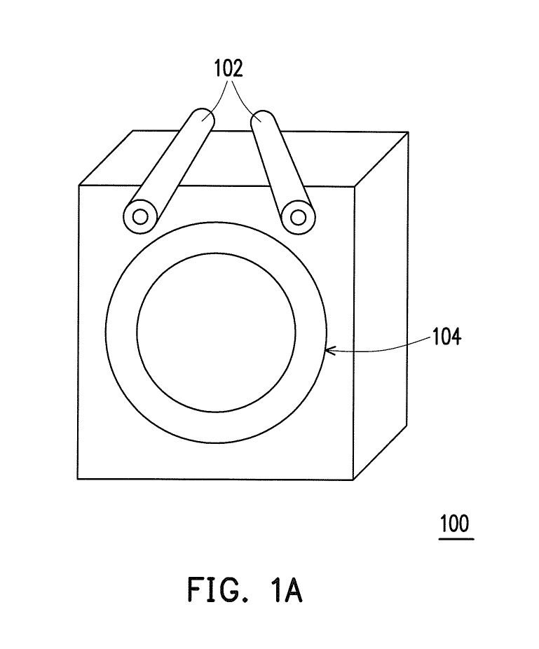

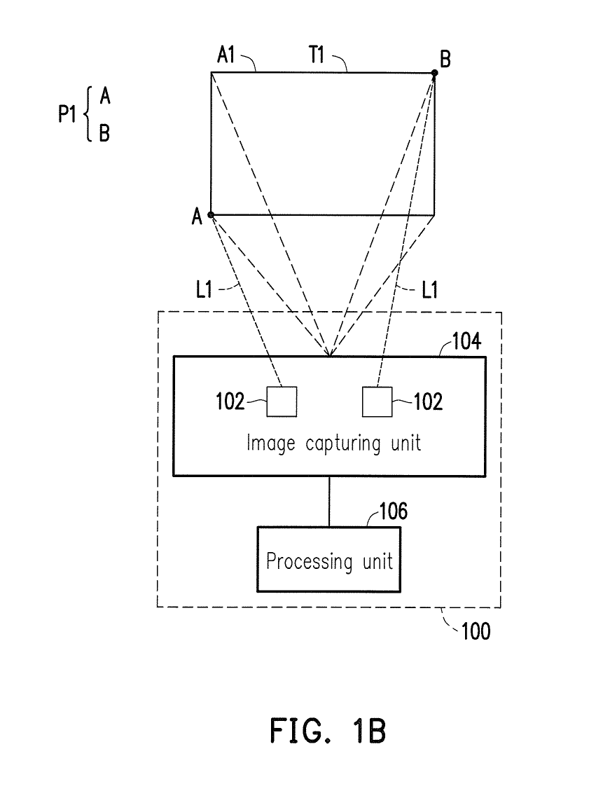

FIG. 1A is a schematic diagram of an image capturing apparatus according to an embodiment of the invention. FIG. 1B and FIG. 1C are block diagrams of the image capturing apparatus according to two embodiments of the invention. Referring to FIG. 1A to FIG. 1C, the image capturing apparatus 100 includes an indicating unit 102, image capturing unit 104, and a processing unit 106, wherein the processing unit 106 is coupled to the image capturing unit 104. The indicating unit 102 is used for emitting an indicating light beam L1 to form an indicating pattern P1 on an image capturing target T1. In the embodiment, the image capturing target T1 is, for example, a projection screen, an electronic whiteboard, a wall, a ceiling or other objects, backgrounds, etc., and the indicating pattern P1 may serve as a reference for at least one of a user (not shown) and the processing unit 106 to determine an operating range, wherein the processing unit 106 may confirm a position of the indicating pattern P1 through the image capturing unit 104.

In detail, in the embodiment, the indicating pattern P1 is configured to indicate the operating range, such that at least one of the user and the processing unit 106 may determine the operating range by aligning the indicating pattern P1 with the image capturing target T1. For example, in the embodiment of FIG. 1B, a desired image capturing range of the image capturing unit 104 is, for example, a rectangle area A1, i.e. the desired image capturing range of the image capturing unit 104, for example, happens to be the image capturing target T1, the indicating pattern P1 composed of a plurality of light spots (a light spot A and a light spot B) may be used to define an indicating area (for example, the rectangle area A1) to be overlapped/coincided with the image capturing target T1. In the embodiment, the indicating light beam L1 emitted by the indicating unit 102 is a visible light beam to cause the user to be able to directly know a position of the rectangle area A1 by naked eyes to serve as a reference for the image capturing operation, so as to know an approximate image capturing position of the image capturing unit 104. Moreover, in the embodiment, two light spots A and B are provided for the user to easily imagine the rectangle area A1. Namely, in the embodiment, the user may determine the position of the rectangle area A1 only according to two vertexes (the light spot A and the light spot B) on a certain diagonal of the rectangle area A1, so that the user may determine an operating range (for example, the image capturing range) of the image capturing unit 104. Similarly, in other embodiments, the processing unit 106 may also determine the image capturing range of the image capturing unit 104 according to the indicating pattern P1 having a plurality of light spots. Therefore, the indicating pattern P1 may assist the user and/or the processing unit 106 in determining the image capturing range of the image capturing unit 104.

According to the above description, in the embodiment of FIG. 1B, the operating range is, for example, the image capturing range of the image capturing unit 104, and a boundary of the rectangle area A1 used for indicating the operating range is, for example, overlapped/coincided with a boundary of the image capturing target T1 (the image capturing range), i.e. the operating range (the rectangle area A1) substantially covers the image capturing range (the image capturing target T1). However, the invention is not limited thereto. For example, in the embodiment of FIG. 1C, the operating range is, for example, the image capturing range of the image capturing unit 104, but the rectangle area A1 used for indicating the operating range, for example, only covers a part of the image capturing target T1 (the image capturing range). In other embodiments that are not illustrated, the boundary of the rectangle area A1 used for indicating the operating range may also exceed the boundary of the image capturing target T1.

However, in a part of the embodiments, the image capturing range indicated by the light spot A and the light spot B may be different to an image captured by the image capturing unit 104 or an image output after the image capturing operation. Namely, the image captured by the image capturing unit 104 or the image output after the image capturing operation may be an image only including a part of or all of objects within the rectangle area A1 defined by the light spot A and the light spot B, or an image including the objects covered by both of the inside of the rectangle area A1 and the outside of the rectangle area A1.

Therefore, since the light spot A and the light spot B are formed by the visible light beam L1, in the circumstance of the image captured and output by the image capturing unit 104 including a part of the objects within the rectangle area A1 or including the objects within the rectangle area A1 and outside the rectangle area A1, the user may know an approximate capturing position of the image capturing unit 104 through the naked eyes. However, in the circumstance of the image captured and output by the image capturing unit 104 only including all of the objects within the rectangle area A1, the user may know an accurate capturing position of the image capturing unit 104 through the naked eyes.

After the image capturing operation is determined, the user may cause the processing unit 106 to control the image capturing unit 104 to perform the image capturing operation and to take the captured image as an output image through sending an image output instruction to the processing unit 106 (for example, through pressing a virtual or physical button). The image capturing range of the image capturing apparatus may be known according to the indicating pattern P1, it may be unnecessary to display the image capturing range of the image capturing apparatus through a display apparatus for the user, such that the usage convenience of the image capturing apparatus is improved.

Moreover, the aforementioned indicating pattern P1 is only a schematic example, and the invention is not limited thereto. For example, the indicating pattern P1 may also include a plurality of indicating spots (i.e. more light spots). In some embodiments, the indicating pattern P1 may also be composed of dots, lines, lines and dots or other patterns.

On the other hand, the processing unit 106 may actively analyze the capturing image captured by the image capturing unit 104, so as to execute a predetermined operation according to the indicating pattern P1 in the capturing image. For example, when the processing unit 106 receives an image output instruction, the processing unit 106 may actively determine the image capturing range of the image capturing unit 104 according to the indicating pattern P 1. In detail, it is assumed that the image capturing unit 104 is a camera or a video camera, the processing unit 106 may control the image capturing unit 104 to adjust a magnifying power of a lens of the image capturing unit 104 to adjust the image capturing range to be the rectangle area A1, and takes the captured image as an output image. Alternatively, the processing unit 106 may not adjust the magnifying power of the image capturing unit 104, but further captures an image within the rectangle area A1 from an image (the image with an image range greater than or equal to the rectangle area A1) captured by the image capturing unit 104 for outputting.

However, when the processing unit 106 determines the image capturing range of the image capturing unit 104 according to the indicating pattern P1, the image capturing range is, for example, the rectangle area A1 defined by the light spot A and the light spot B. However, the invention is not limited thereto, and in other embodiments, the image capturing range may also be greater than or equal to the rectangle area A1.

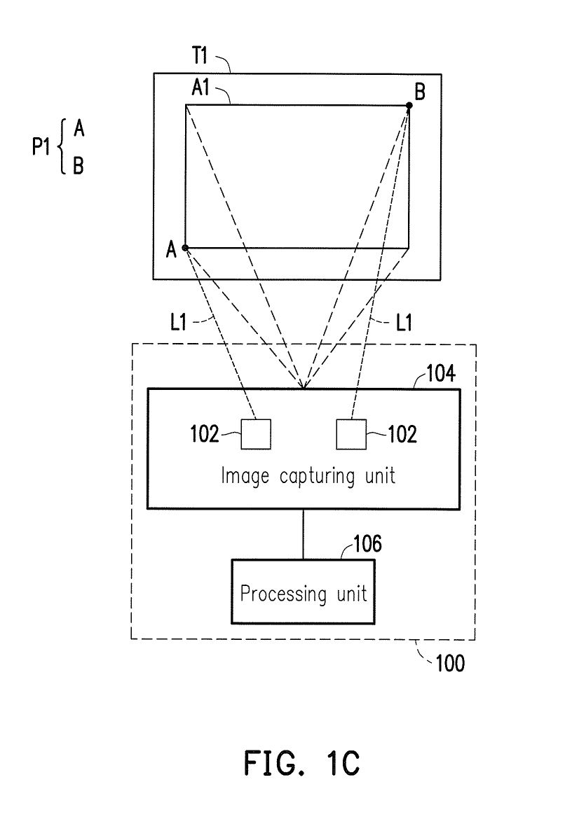

The aforementioned image capturing apparatus may also be applied to an interactive display system. FIG. 2 is a schematic diagram of an interactive display system according to an embodiment of the invention. Referring to FIG. 2, in the embodiment, besides the image capturing apparatus 100, the interactive display system 200 further includes a display unit 202, and the display unit 202 is configured to display an image F1. In the embodiment, the image capturing target of the image capturing apparatus 100 is the image F1, and the image capturing unit 104 of the image capturing apparatus 100 may be controlled by the processing unit 106 to capture at least a part of the image F1 to generate a capturing image. Moreover, the display unit 202 of the embodiment is a projector configured to project an image light beam onto a projection surface, so as to project the image F1 on the projection surface. Similarly, the indicating unit 102 of the embodiment may also produce the indicating pattern P1 (for example, the light spot A and the light spot B, though the invention is not limited thereto) on the image F1, so as to define the rectangle area A1 to serve as a reference for further determining the operating range. In the embodiment, since a technical feature about at least one of the user and the processing unit 102 determining the operating range by aligning the indicating pattern P1 with at least a part of the image F1 is similar to the technical feature of the embodiments of FIG. 1B and FIG. 1C about at least one of the user and the processing unit 102 determining the operating range by aligning the indicating pattern P1 with the image capturing target T1, a detailed description is not repeated.

According to the above description, different to the embodiments of FIG. 1B and FIG. 1C, in the embodiment, the predetermined operation executed by the processing unit 106 within the operating range according to the indicating pattern P1 may include a touch operation, and the operating range indicated by the indicating pattern P1 may be an interactive display range of the interactive display system 200. In detail, the processing unit 106 may control the image capturing unit 104 to capture an image within the rectangle area A1 according to the indicating pattern P1, so as to obtain the capturing image, and determines whether a touch operation is occurred within the operating range (i.e. the rectangle area A1) according to the capturing image, for example, determines whether the touch operation is occurred according to a variation of image content of the capturing image. When the touch operation is occurred within the operating range, the processing unit 106 executes an operation corresponding to the touch operation, for example, the processing unit 106 calculates coordinates of the touch position to obtain a coordinate signal and transmits the coordinate signal to a host machine (not shown) to execute the operation corresponding to the touch operation.

As described above, since the user and/or the processing unit 106 may directly determine the position of the touch area (i.e. the rectangle area A1) according to the indicating light beam L1 (e.g. a visible light beam) emitted by the indicating unit 104, when the user has to adjust the relative positions among the projector, the projection screen, and the image capturing apparatus 100, a complicated adjustment may be avoided through the indicating pattern P1 formed by the indicating light beam L1. In the aforementioned embodiment, since the required touch area may be quickly and intuitively adjusted, the usage convenience of the interactive display system 200 may be greatly improved. For example, when the interactive display system is applied to a teaching activity, the user may quickly and easily adjust the positions of the projector and the image capturing apparatus according to a right-handed or left-handed habit of a teacher, so as to adjust light paths of the projection light beam and the indicating light beam to avoid a situation that the body of the teacher blocks the projection light beam and the indicating light beam to cause a shadow to influence an interaction effect of the interactive display system.

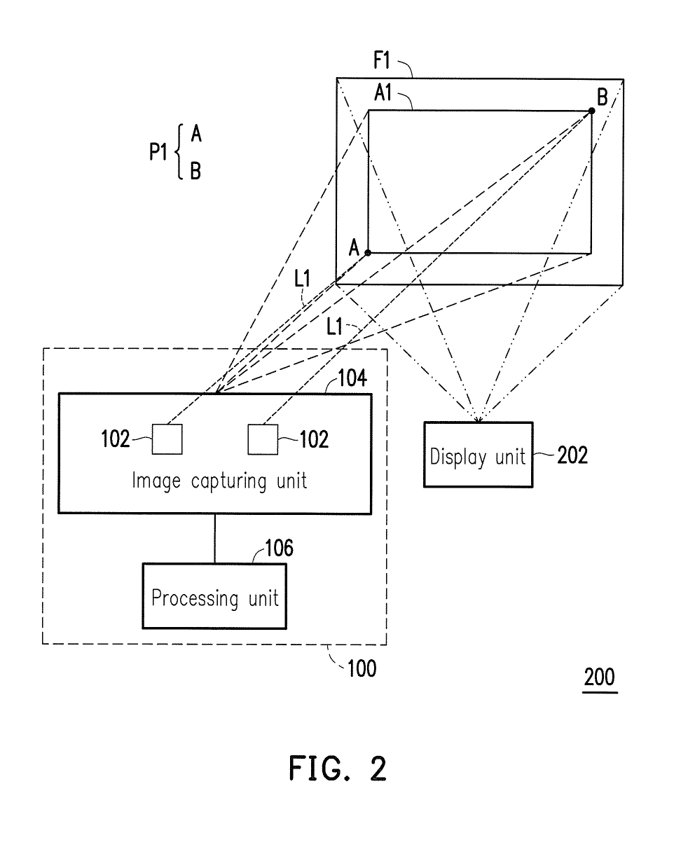

However, in the interactive display system, the number of the image capturing apparatuses is not limited. FIG. 3 is a schematic diagram of an interactive display system according to another embodiment of the invention. The interactive display system 300 of FIG. 3 may further include an image capturing apparatus 100-1, wherein the image capturing apparatus 100-1 includes an indicating unit 302, an image capturing unit 304, and a processing unit 306. In the embodiment, the indicating unit 302 is, for example, adapted to emit an indicating light beam L2 (e.g. a visible light beam) to form an indicating pattern P2 on the image F1 provided by the display unit 202. The indicating pattern P2 may include a light spot C and a light spot D, and the light spot C and the light spot D may define a rectangle area A2. Moreover, functions of the image capturing unit 304 and the processing unit 306 are similar to functions of the image capturing unit 104 and the processing unit 106 of the aforementioned embodiment, so that details are not repeated. Therefore, in the embodiment, by adding one image capturing apparatus 100-1, a touch operation range of the interactive display system is increased, so as to further improve the usage convenience of the interactive display system 300.

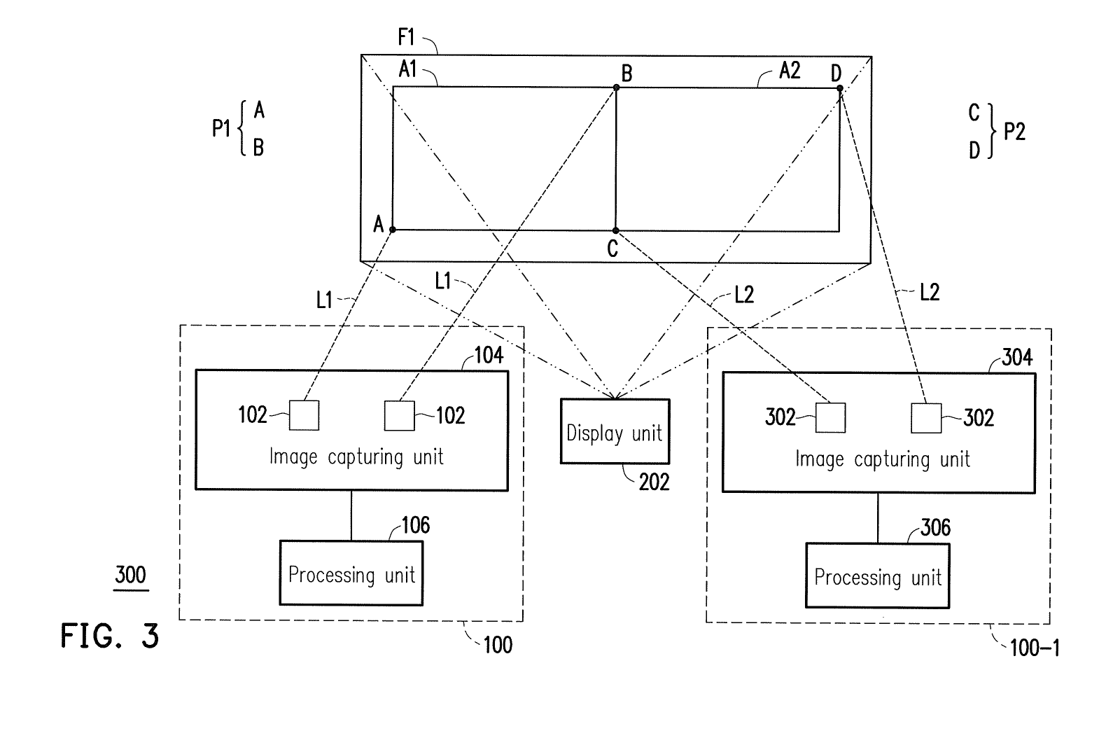

Moreover, the display unit 202 is not limited to be implemented by a projector. FIG. 4 is a schematic diagram of an interactive display system according to another embodiment of the invention. In the embodiment, the display unit 402 of the interactive display system 400 is implemented by a touch display panel. The display unit 402 used for displaying the image F1 is coupled to the processing unit 106, and is adapted to detect a touch operation to generate a touch signal to the processing unit 106. The processing unit 106 may determine whether the touch operation is occurred within the operating range according to the touch signal and the capturing image captured by the image capturing unit 104, and when the touch operation is occurred within the operating range, the operation corresponding to the touch operation is executed. However, the related technical features of using the indicating pattern P1 to assist at least one of the user and the processing unit 106 in determining the operating range has been described in the aforementioned embodiment, so that a detailed description is not repeated.

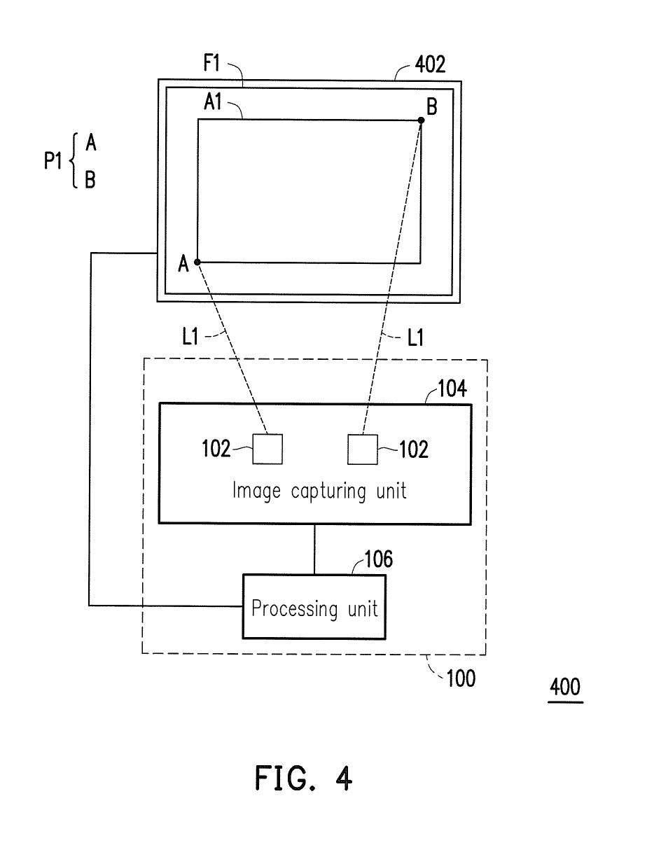

FIG. 5 is a flowchart illustrating an image capturing method according to an embodiment of the invention. Referring to FIG. 5, according to the aforementioned embodiment, it is known that the image capturing method of the image capturing apparatus may include following steps. First, an indicating unit of an image capturing apparatus is used to emit an indicating light beam, so as to form an indicating pattern on an image capturing target (step S502), wherein the indicating light beam may be a visible light beam, and the indicating pattern may include a plurality of indicating spots. Then, an image capturing unit of the image capturing apparatus is used to capture the image capturing target to generate a capturing image, wherein the indicating pattern is configured to assist at least one of a user and the image capturing apparatus to determine an operating range (step S504). In the embodiment, at least one of the user and the image capturing apparatus may determine the operating range by aligning the indicating pattern with the image capturing target, wherein the operating range may be an image capturing range of the image capturing unit. For example, the image capturing apparatus may analyze the capturing image to execute a predetermined operation within the operating range according to the indicating pattern. The predetermined operation is, for example, to receive an image output instruction, and control the image capturing range of the image capturing unit according to the indicating pattern, so as to capture an image within the operating range to serve as an output image; or to receive the image output instruction, and capture an image within the operating range from the capturing image to serve as the output image according to the indicating pattern.

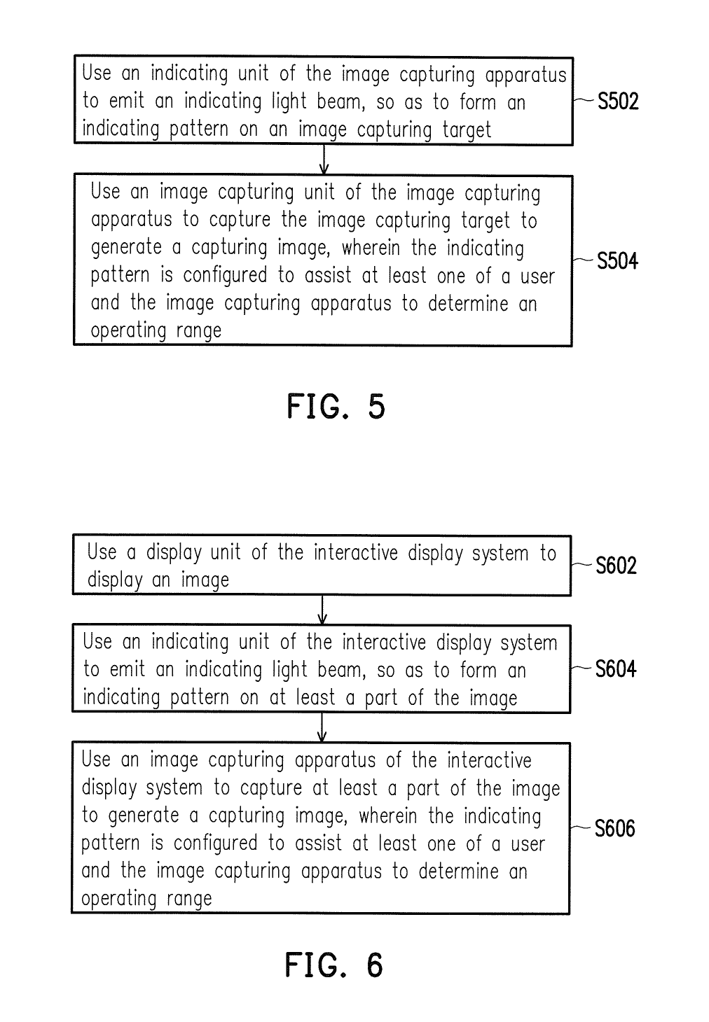

FIG. 6 is a flowchart illustrating an interactive display method according to another embodiment of the invention. Referring to FIG. 6, according to the aforementioned embodiment, it is known that the interactive display method of the interactive display system may include following steps. First, a display unit of the interactive display system is used to display an image (step S602), wherein the indicating light beam may be a visible light beam, the indicating pattern may include a plurality of indicating spots, and the display unit is, for example, a projector adapted to project an image light beam onto a projection surface to display the image. Then, an indicating unit of the interactive display system is used to emit an indicating light beam to form an indicating pattern on a least a part of the image (step S604). Then, an image capturing apparatus of the interactive display system is used to capture at least a part of the image to generate a capturing image, wherein the indicating pattern is configured to assist at least one of a user and the image capturing apparatus to determine an operating range (step S606). In the embodiment, at least one of the user and the image capturing apparatus may determine the operating range by aligning the indicating pattern with at least a part of the image, wherein the operating range may be an image capturing range of the image capturing apparatus and/or an interactive display range of the interactive display system. For example, the image capturing apparatus may analyze the capturing image to execute a predetermined operation within the operating range according to the indicating pattern. The predetermined operation is, for example, to determine whether a touch operation is occurred within the operating range according to the capturing image, and execute the operation corresponding to the touch operation when the touch operation is occurred within the operating range. Moreover, in some embodiments, the image may be displayed by a touch display panel, and in this case, the image capturing apparatus may analyze the capturing image and receive a touch signal generated by sensing a touch operation through the touch display panel, and determine whether the touch operation is occurred within the operating range according to the touch signal and the capturing image.

In summary, the embodiment of the invention forms the indicating pattern on the image to assist at least one of the user and the processing unit in determining the operating range through the indicating light beam emitted by the indicating unit, the user is assisted to quickly determine an image capturing position, such that the sensing range of the interactive touch may be adjusted to the required position, therefore usage convenience is greatly improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An interactive display system, comprising:
a display unit, displaying an image; and
an image capturing apparatus, capturing at least a part of the image, and the image capturing apparatus comprising:
an image capturing unit, generating a capturing image;
an indicating unit, emitting an indicating light beam to form an indicating pattern on the image; and
a processing unit, coupled to the image capturing unit, and controlling the image capturing unit to capture at least a part of the image to generate the capturing image, wherein the indicating pattern is configured to assist at least one of a user and the processing unit in determining an operating range.

2. The interactive display system as claimed in claim 1, wherein the display unit is a projector, and the projector is configured to project the image.

3. The interactive display system as claimed in claim 1, wherein the indicating light beam is a visible light beam.

4. The interactive display system as claimed in claim 1, wherein the indicating pattern has a plurality of indicating spots.

5. The interactive display system as claimed in claim 1, wherein at least one of the user and the processing unit determines the operating range by aligning the indicating pattern with at least a part of the image.

6. The interactive display system as claimed in claim 1, wherein the operating range is an image capturing range of the image capturing unit.

7. The interactive display system as claimed in claim 1, wherein the operating range is an interactive display range of the interactive display system.

8. An image capturing apparatus, comprising:
an indicating unit, emitting an indicating light beam to form an indicating pattern on an image capturing target;
an image capturing unit, generating a capturing image; and
a processing unit, coupled to the image capturing unit, and controlling the image capturing unit to capture the image capturing target to generate the capturing image, wherein the indicating pattern is configured to assist at least one of a user and the processing unit in determining an operating range.

9. The image capturing apparatus as claimed in claim 8, wherein the indicating light beam is a visible light beam.

10. The image capturing apparatus as claimed in claim 8, wherein the indicating pattern has a plurality of indicating spots.

11. The image capturing apparatus as claimed in claim 8, wherein at least one of the user and the processing unit determines the operating range by aligning the indicating pattern with the image capturing target.

12. The image capturing apparatus as claimed in claim 8, wherein the operating range is an image capturing range of the image capturing unit.

13. An interactive display method, adapted to an interactive display system, and the interactive display method comprising:
using a display unit of the interactive display system to display an image;
using an indicating unit of the interactive display system to emit an indicating light beam, so as to form an indicating pattern on at least a part of the image; and
using an image capturing apparatus of the interactive display system to capture at least a part of the image to generate a capturing image, wherein the indicating pattern is configured to assist at least one of a user and the image capturing apparatus in determining an operating range.

14. The interactive display method as claimed in claim 13, wherein the step of using the display unit of the interactive display system to display the image comprises:
using the display unit to project an image light beam to a projection surface, so as to display the image on the projection surface.

15. The interactive display method as claimed in claim 13, wherein the step that the indicating pattern assists at least one of the user and the image capturing apparatus in determining the operating range comprises:
at least one of the user and the image capturing apparatus determining the operating range by aligning the indicating pattern with at least a part of the image.

16. The interactive display method as claimed in claim 13, wherein the indicating light beam is a visible light beam, and the indicating pattern has a plurality of indicating spots.

17. The interactive display method as claimed in claim 13, wherein the operating range is an image capturing range of the image capturing apparatus.

18. The interactive display method as claimed in claim 13, wherein the operating range is an interactive display range of the interactive display system.

19. An image capturing method, adapted to an image capturing apparatus, and the image capturing method comprising:
using an indicating unit of the image capturing apparatus to emit an indicating light beam, so as to form an indicating pattern on an image capturing target; and
using an image capturing unit of the image capturing apparatus to capture the image capturing target to generate a capturing image, wherein the indicating pattern is configured to assist at least one of a user and the image capturing apparatus in determining an operating range.

20. The image capturing method as claimed in claim 19, wherein the step that the indicating pattern assists at least one of the user and the image capturing apparatus in determining the operating range comprises:
at least one of the user and the image capturing apparatus determining the operating range by aligning the indicating pattern with the image capturing target.

21. The image capturing method as claimed in claim 19, wherein the indicating light beam is a visible light beam, and the indicating pattern has a plurality of indicating spots.

22. The image capturing method as claimed in claim 19, wherein the operating range is an image capturing range of the image capturing unit.
